(19) United States
(12) Patent Application Publication
(10) Pub. No.: US 2011/0096106 A1
(43) Pub. Date: Apr. 28, 2011

(54) TIMING CONTROL CIRCUIT

(75) Inventors: Yoko Nomaguchi, Ukyo-Ku (JP); Toshihide Komiya, Ukyo-Ku (JP)

(73) Assignee: ROHM CO., LTD., Kyoto (JP)

(21) Appl. No.: 12/647,710

(22) Filed: Dec. 28, 2009

(30) Foreign Application Priority Data
Dec. 26, 2008 (JP) 2008-334256
Dec. 1, 2009 (JP) 2009-273881

(51) Int. Cl. G09G 5/10

(52) U.S. Cl. 345/691

(57) ABSTRACT

A timing controller is connected via a common bus to multiple data drivers which drive a display panel. A reception interface circuit receives image data including each color (R, G, and B). A timing control unit controls the timing of the luminance data for each color, i.e., R, G, and B, such that it conforms to the multiple data drivers provided as the transmission destinations. A transmission interface circuit transmits the luminance data for each color, the timing of which is controlled by the timing control unit, and a synchronization clock, to the multiple data drivers via the common bus. The transmission interface circuit is configured so as to independently adjust the respective phases of the synchronization clock and the luminance data for each color to be output to the bus.

### BACKGROUND OF THE INVENTION

1. Field of the Invention

The present invention relates to a timing control circuit which supplies driving signals to drivers for a liquid crystal panel.

2. Description of the Related Art

Liquid crystal displays (LCDs), plasma displays, and organic EL displays (which will be collectively referred to as “display apparatuses” hereafter) include a display panel having a configuration including multiple pixels arranged in the form of a matrix, scanning lines provided in increments of rows of the matrix, and data lines provided in increments of columns thereof. FIG. 1 is a block diagram which shows a typical configuration of a display apparatus 300. The display apparatus 300 includes a display panel 302, data drivers (source drivers) 306 which drive the multiple data lines, and scanning drivers (gate drivers) 304 which drive the multiple scanning lines.

The number of data lines which can be driven by a single data driver 306 and the number of scanning lines which can be driven by a single scanning driver 308 are determined beforehand. Accordingly, the display apparatus 300 includes data drivers 306 and scanning drivers 304, the numbers of which respectively correspond to the number of data lines and the number of scanning lines.

The display apparatus 300 receives, as input data, image data GD in the form of digital data or analog data, from a graphic processor, tuner unit, DVD player, or the like. In some cases, the image data GD is generated within the display apparatus 300. The image data GD includes luminance data DR, DG, and DB for the three RGB colors, regardless of the signal format, i.e., regardless of whether an analog signal format or a digital signal format is employed. The image data GD is temporarily input to a circuit block, which will be referred to as a “timing controller 100”, before the image data GD is distributed to the scanning drivers 304 and the data drivers 306.

The timing controller 100 is connected to the multiple scanning drivers 304 via a common bus 309. Furthermore, the timing controller is connected to the multiple data drivers 304 via the common bus 309. For example, description will be made regarding a liquid crystal display as an example. In this case, a high-speed differential transmission method is employed for data transmission between the multiple data drivers 306 and the timing controller 100, examples of which include mini-LVDS (Low Voltage Differential Signaling), RSDS (Reduced Swing Differential Signaling), etc.

With mini-LVDS, the luminance data DR, DG, and DB provided in the form of differential data for the respective colors (R, G, and B) are transmitted along with a synchronization clock CLK. On the receiving side, the luminance data DR, DG, and DB are latched at a positive edge timing or a negative edge timing of the synchronization clock CLK.

### RELATED ART DOCUMENTS

### Patent Documents

### [Patent Document 1]

Japanese Patent Application Laid-Open No. Hei06-273788

### [Patent Document 2]

Japanese Patent Application Laid Open No. 2003-173150

### [Patent Document 3]

Japanese Patent Application Laid Open No. 2002-135234

The buses 309 between the timing controller 100 and the multiple data drivers 306 are preferably arranged such that the respective wiring length and the respective wiring impedance are uniform. However, in many cases, in an actual display apparatus, the wiring length and the wiring impedance are different for each path due to the limiting conditions under which the display apparatus is designed. In a case in which each path has a different wiring length or wiring impedance, a timing gap (skew) occurs in the multiple data drivers 306 between the synchronization clock CLK and the luminance data DR, DG, and DB. This leads to a violation of the setup time or a violation of the hold time in any one of the multiple data drivers 306, resulting in data acquisition error.

As a method for solving the aforementioned problem, a clock skew adjustment method has been proposed, in which the phase of the synchronization clock CLK to be transmitted from the timing controller 100 to the bus 309 is adjusted for the luminance data DR, DG, and DB. At present, the transmission frequency employed in the high-speed differential transmission method is around 150 MHz. However, in the near future, it is possible that the transmission frequency will increase to, for example, double the current transmission frequency, i.e., to 300 MHz, and that such an arrangement employing only the clock skew adjustment method would not be able to solve the aforementioned problem.

### SUMMARY OF THE INVENTION

The present invention has been made in order to solve such a problem. Accordingly, it is an exemplary purpose of an embodiment of the present invention to provide a timing controller which is capable of transmitting luminance data at high speed to multiple data drivers.

The present invention relates to a timing control circuit connected via a common bus to multiple data drivers configured to drive a display panel. The timing control circuit comprises: a reception interface circuit configured to receive luminance data provided for each color; a timing control unit configured to control the timing of the luminance data for each color such that they conform to the multiple data drivers provided as transmission destinations; and a transmission interface circuit configured to transmit luminance data, which has been provided for each color and the timing of which has been controlled by the timing control unit, and a synchronization clock, to the multiple data drivers via the common bus. The transmission interface circuit is configured so as to independently adjust the respective phases of the synchronization clock and the luminance data provided for each color to be output to the bus.

With such an embodiment, the respective phases of the synchronization clock and of all the luminance data can be independently adjusted in increments of lines. Thus, such an embodiment can control the skew between the clock and the data, thereby allowing the data to be transmitted to the multiple data drivers in a sure manner even if the transmission frequency is high.

Also, the timing control circuit according to an embodiment may further comprise an oscillator configured to generate a multi-phase clock including multiple clocks having phases that differ from one another. Also, the transmission interface circuit may be configured to select, from among the multiple clocks included in the multi-phase clock, one clock that corresponds to the phase required for the synchronization clock, and to generate the synchronization clock based upon the clock thus selected. Also, the transmission interface circuit may be configured to select, from among the multiple clocks included in the multi-phase clock, one clock that corresponds to the phase required for the luminance data for each color, and to output the luminance data for each color retimed using the clock thus selected.

Also, the transmission interface circuit may include: a first variable delay circuit configured to apply, to the synchronization clock, a delay that corresponds to the phase required for the synchronization clock; and a second variable delay circuit arranged for luminance data for each color, and configured to apply, to the corresponding luminance data, a delay that corresponds to the phase required for the luminance data.

Another embodiment of the present invention relates to a display apparatus. The display apparatus comprises: a display panel; at least one scanning driver configured to drive the display panel; multiple data drivers configured to drive the display panel; and a timing control circuit according to any one of the above-described embodiments, configured to transmit luminance signals and a synchronization clock to the data drivers.

Such an embodiment reduces the possibility of transmission error that occurs between the timing control circuit and each data driver. This improves the image quality. Also, this relaxes the limiting conditions under which the display apparatus is designed.

It is to be noted that any arbitrary combination or rearrangement of the above-described structural components and so forth is effective as and encompassed by the present embodiments.

Moreover, this summary of the invention does not necessarily describe all necessary features so that the invention may also be a sub-combination of these described features.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a block diagram which shows an ordinary configuration of a display apparatus;

FIG. 2 is a diagram which shows a timing controller IC according to an embodiment and a peripheral circuit thereof;

FIG. 3 is a circuit diagram which shows an example configuration of a transmission interface circuit;

FIG. 4 is a time chart which shows the operation of a timing controller according to an embodiment; and

FIG. 5 is a block diagram which shows a timing control circuit.

### DETAILED DESCRIPTION OF THE INVENTION

The invention will now be described based on preferred embodiments which do not intend to limit the scope of the present invention but exemplify the invention. All of the features and the combinations thereof described in the embodiment are not necessarily essential to the invention.

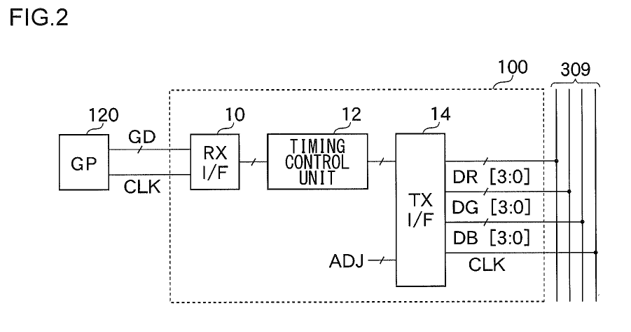

FIG. 2 is a diagram which shows a timing controller IC (which will be referred to as the “timing controller IC”) 100 according to an embodiment and peripheral components thereof. The timing controller IC 100 receives image data GD, which is to be output to a liquid crystal panel (not shown), from an external processor 120, and performs predetermined signal processing as necessary, examples of which include scaling processing, interlacing processing, and non-interlacing processing. After adjusting the timing at which each signal is to be output, the timing controller IC 100 outputs vertical synchronization signals to multiple scanning drivers 304, and luminance signals and horizontal synchronization signals to multiple data drivers 306.

The timing controller IC 100 includes a reception interface circuit 10, a timing control unit 12, and a transmission interface circuit 14, and is provided as a built-in component included within a single package.

The reception interface circuit 10 receives, as input signals, image data GD (luminance data provided in increments of colors) and a clock signal CLK from a processor. The input signals are provided in a differential signaling format such as LVDS (Low Voltage Differential Signaling). Also, the input signals may be provided as parallel CMOS input signals.

The timing control unit 12 receives the luminance data received by the reception interface circuit 10, and controls the timing at which the luminance data are to be transmitted and the format of the luminance data such that they conform to the multiple data drivers (not shown) and the multiple scanning drivers (not shown).

The transmission interface circuit 14 transmits the luminance data DR, DG, and DB, thus generated by the timing control unit 12, to the multiple data drivers (not shown) via a common bus 309. The luminance data DR, DG, and DB, which constitute a single pixel, are each provided in the form of 8-bit data. The bus 309 includes parallel 4-bit lines for each of the R, G, and B data, and a line for a synchronization clock CLK. That is to say, the bus 309 includes twelve data lines and a single clock line. It should be noted that each line of the bus is configured as a pair of differential lines. The luminance data DR[3:0] includes one bit of data at each positive edge and each negative edge of the synchronization clock CLK. Accordingly, the luminance data DR transmits 8 (=4×2) bits of data for each cycle of the synchronization clock CLK. The same can be said of the luminance data DG and DB. It should be noted that the number of bits per pixel may be 6 bits, 10 bits, 12 bits, or the like, depending on the application. In this case, the number of bus lines is modified according to the number of bits. Also, the number of bits to be serialized and the number of lines of the differential bus differ depending on the transmission method, such as RSDS, mini-LVDS, etc. Accordingly, it is needless to say that a design suitable for the transmission method should be made.

The transmission interface circuit 14 is configured so as to independently set the respective phases of the synchronization clock CLK and the luminance data DR[3:0], DG[3:0], and DB[3:0], based upon adjustment data ADJ prepared beforehand.

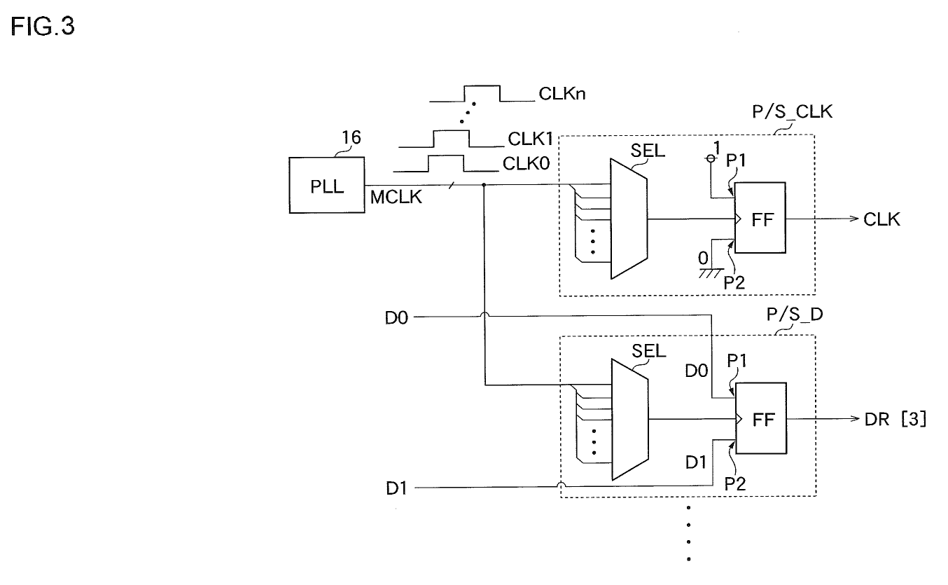

FIG. 3 is a circuit diagram which shows an example configuration of the transmission interface circuit 14. The transmission interface circuit 14 includes an oscillator 16 which generates an n-phase clock (n is an integer of 2 or more) including multiple clocks CLK1 through CLKn each having mutually different phases. The phase shift between adjacent clocks CLKi and CLK(i+1) is (360/n) degrees. Such a multi-phase clock can be generated using known techniques. For example, PLL (Phase Locked Loop) circuits can be suitably employed. Alternatively, such a multi-clock may be generated using a ring oscillator. The method for generating such a multi-phase clock is not restricted in particular.

The transmission interface circuit 14 selects one clock that corresponds to the phase required for the synchronization clock CLK to be output to the bus 309, from among the multiple clocks CLK1 through CLKn that constitute the multi-phase clock MCLK. The transmission interface circuit 14 generates the synchronization clock CLK based upon the clock thus selected. The aforementioned adjustment data ADJ is input to a selector SEL. The adjustment data ADJ is generated by the designer who designs the display apparatus 300, and is written to unshown nonvolatile memory (EEPROM, FeRAM, or the like). Alternatively, an arrangement in which the adjustment data ADJ is received from an external host processor via an I2C bus is effective as an embodiment of the present invention.

Furthermore, the transmission interface circuit 14 selects one clock that corresponds to the phase required for the respective luminance data, from among the multiple clocks CLK1 through CLKn that constitute the multi-phase clock MCLK. The transmission interface circuit 14 outputs the respective luminance data retimed using the clock thus selected.

In order to provide the aforementioned two functions, the transmission interface circuit 14 includes a clock parallel/serial conversion circuit P/S_CLK and data parallel/serial conversion circuits P/S_D provided in increments of lines of the bus 309, i.e., provided in increments of bit lines for the synchronization clock and the luminance data to be transmitted. FIG. 3 shows only a single parallel/serial conversion circuit P/S_D provided for the luminance data DR[3] in order to simplify explanation.

The parallel/serial conversion circuit P/S_CLK includes: a selector SEL which receives the multiple clocks CLK1 through CLKn, and selects one set beforehand from among the multiple clocks thus received; and a flip-flop FF which latches the data input via a first input terminal P1 at a positive edge timing of the clock CLKi (i≦i≦n) thus selected by the selector SEL, and latches the data input via a second input terminal P2 at a negative edge timing thereof. The high-level signal (1) is input to the first input terminal P1 of the flip-flop FF, and the low-level signal (0) is input to the second input terminal P2 thereof. With such an arrangement, by selecting, by means of the selector SEL, the clock CLKi to be selected, a desired phase of the synchronization clock CLK can be selected from among n phases. Also, the clock CLKi selected by the selector SEL may be directly output or may be output via a buffer, as the synchronization clock CLK, without involving the flip-flop FF.

Furthermore, the data parallel/serial conversion circuit P/S_D has the same configuration as that of the clock parallel/serial conversion circuit P/S_CLK. Two-bit parallel luminance data D0 and D1 are input to the data parallel/serial conversion circuit P/S_D. Specifically, first data D0 is input to the first input terminal P1 of the flip-flop FF, and second data D1 is input to the second input terminal P2 thereof. With such an arrangement, the parallel luminance data D0 and D1 can be converted into serial data. Furthermore, such an arrangement is capable of selecting, as the phase of the luminance data DR[3], a desired phase from among n phases by selecting and switching the clock CLKi by means of the selector SEL.

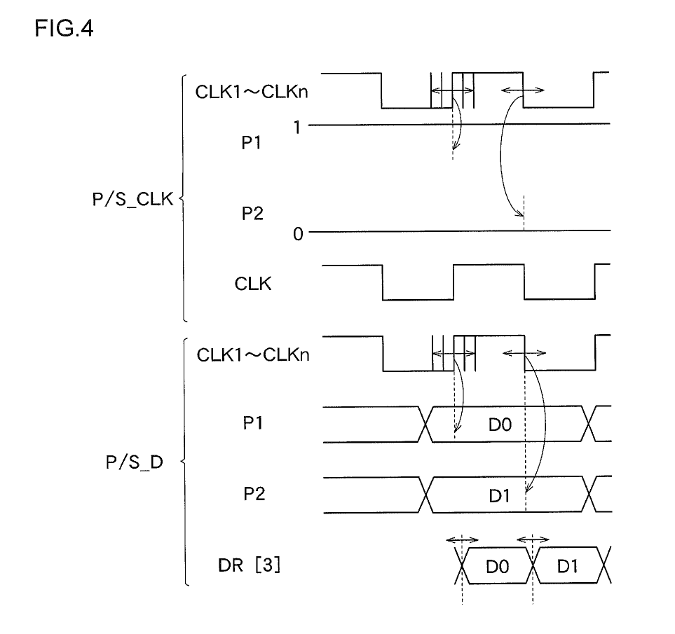

The above is the configuration of the timing controller 100. Next, description will be made regarding the operation thereof. FIG. 4 is a time chart which shows the operation of the timing controller 100 according to the embodiment. The upper graph in FIG. 4 shows the operation of the clock parallel/serial conversion circuit P/S_CLK, and the lower graph thereof shows the operation of the data parallel/serial conversion circuit P/S_D.

With the timing controller 100 according to the embodiment, the phase of the synchronization clock CLK to be output to the bus 309 can be set as desired, by means of switching the phase to a phase selected by means of the selector SEL from among the phases of the clocks CLK1 through CLKn. Furthermore, such an arrangement is capable of independently setting the phases of all the respective luminance data DR[3:0], DG[3:0], and DB[3:0]. In contrast to the skew adjustment method for adjusting only the clock, such a function will be referred to as the “separate adjustment function” hereafter.

Such an arrangement allows the designer or manufacturer of the display apparatus 300 to satisfy the conditions such as the setup time, the hold time, and so forth, for all the multiple data drivers 306, using the above-described separate adjustment function of the timing controller 100. This improves the image quality.

With conventional arrangements, because the timing of the luminance data is set to a fixed value, the bus 309 must be designed under extremely severe conditions. On the other hand, with the timing controller 100 according to the embodiment, a certain level of irregularities in the wiring length and impedance of the bus can be resolved by the separate adjustment function of the timing controller 100, thereby relaxing the limiting conditions under which the display apparatus 300 is designed.

Description has been made above regarding the present invention with reference to the embodiments. The above-described embodiment has been described for exemplary purposes only, and is by no means intended to be interpreted restrictively. Rather, it can be readily conceived by those skilled in this art that various modifications may be made by making various combinations of the aforementioned components or processes, which are also encompassed in the technical scope of the present invention. Description will be made below regarding such modifications.

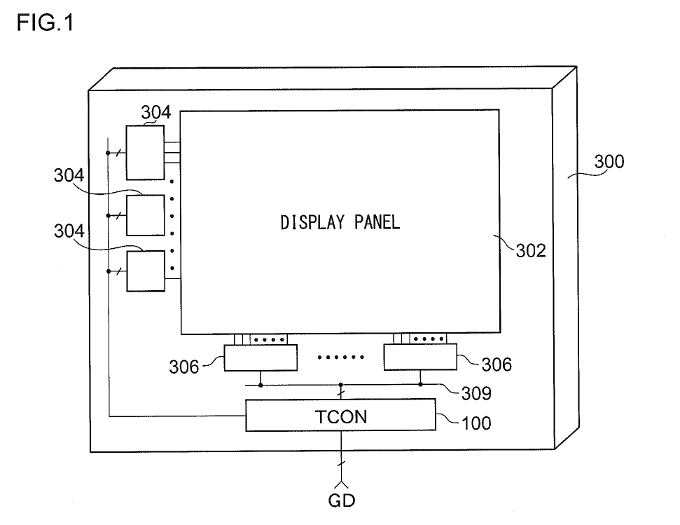

FIG. 1 shows an arrangement in which all the data drivers 306 are connected to the common bus 309. However, the present invention is not restricted to such an arrangement. In a case in which a large-sized display panel 302 is provided, in some cases, the multiple data drivers 306 are partitioned into two groups. With such an arrangement, the multiple data drivers 306 in one group are connected to a common bus 309A, and the other multiple data drivers 306 in the other group are connected to another common bus 309B. In this case, a transmission interface circuit 14 as shown in FIG. 2 is provided for each of the two groups, i.e., for each of the buses 309A and 309B.

Description has been made in the embodiment as shown in FIG. 3 regarding processing in which two-bit parallel data D0 and D1 are subjected to parallel/serial conversion when the luminance data is generated. However, the present invention is not restricted to such an arrangement. For example, an arrangement may be made in which serial data [D1:D0] having two bits for each cycle of the multi-phase clock MCLK is generated, and each bit of the serial data is retimed using both edges of the clock CLKi selected by the selector SEL. Also, an arrangement may be made in which parallel data other than two-bit parallel data is converted into serial data, and the serial data thus converted is transmitted, depending on the transmission method, as described above. In this case, the parallel/serial conversion may be made according to the number of bits.

Description has been made in the embodiment regarding processing in which the timing adjustment for the synchronization clock CLK and the luminance data is performed using a multi-phase clock MCLK. However, the present invention is not restricted to such an arrangement. Rather, any arrangement may be made as long as the respective phases of the synchronization clock CLK and the luminance data can be independently adjusted. For example, an arrangement may be made in which a variable delay circuit is provided for the paths of each of the synchronization clock CLK and the luminance data, which enables the respective delay amounts to be independently adjusted.

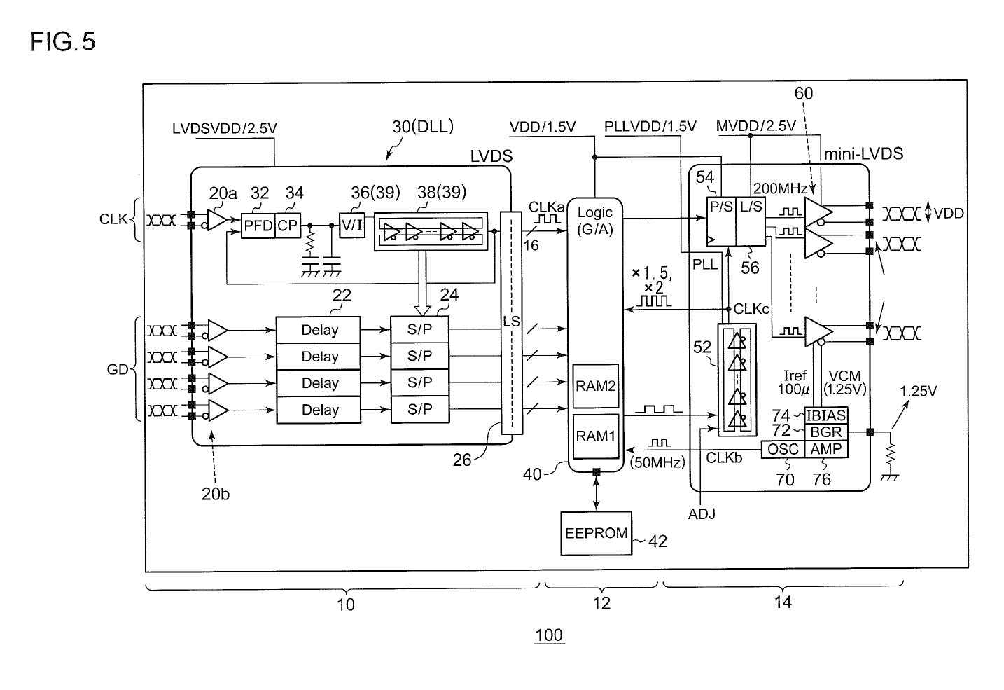

FIG. 5 is a block diagram which shows the timing control circuit.

The reception interface circuit (LVDS) 10 operates under a power supply voltage of 2.5 V. The reception interface circuit 10 includes multiple differential receivers 20, a DLL 30, a delay circuit 22, a serial/parallel conversion circuit 24, and a level shifter 26. Each differential receiver 20 receives the clock signal CLK and the image data GD in a differential format, and converts the data thus received into single-ended signals.

The DLL 30 includes a phase frequency detector 32, a charge pump circuit 34, a voltage/current conversion circuit 36, and a VCO 39. The DLL 30 generates an internal clock signal having a frequency that corresponds to a reference clock signal received from a clock differential receiver 20a. The VCO 39 includes a voltage/current conversion circuit 26 and a ring oscillator 38.

Each of the multiple delay circuits 22 and each of the multiple serial/parallel conversion circuits 24 is provided to the corresponding data differential receiver 20b.

Each delay circuit 22 applies a delay to the output of the corresponding differential receiver 20b. Each serial/parallel conversion circuit 24 performs serial/parallel conversion on the output data of the corresponding delay circuit 22. The level shifter 26 level-shifts a signal having an amplitude of 2.5 V to a signal for a 1.5-V system, and transmits the signal thus level-shifted to the timing control unit 12.

The timing control unit 12 includes a logic unit 40 and EEPROM 42. The timing control unit 12 performs necessary signal processing for the data received from the reception interface circuit 10, and outputs the data thus subjected to the signal processing to the transmission interface circuit 14 provided as a downstream component.

The logic unit 40 monitors whether or not the clock signal CLKa has been received from the reception interface circuit 10. When the clock signal CLKa is input, the logic unit 40 uses the clock signal CLKa thus received. When the clock signal CLKa is not input, a clock signal CLKb received from an oscillator 70 included in the transmission interface circuit 14 is used.

The transmission interface circuit (mini-LVD) 14 includes a PLL 52, a parallel/serial conversion circuit 54, a level shifter 56, multiple differential drivers 60, an oscillator 70, a band gap regulator 72, a bias current source 74, and an amplifier 76.

The oscillator 70 generates a 50 MHz clock signal CLKb, and supplies the clock signal CLKb thus generated to the logic unit 40. The PLL 52 generates a clock signal CLKc obtained by multiplying the clock signal CLKb by 1.5 or 2, and outputs the clock signal CLKc thus multiplied to the parallel/serial conversion circuit 54 and the logic unit 40. The parallel/serial conversion circuit 54 converts the parallel data thus received from the logic unit 40 into serial data. In this case, the clock signal CLKc received from the PLL 52 is used.

The level shifter 56 level-shifts the data, which has a frequency of 200 MHz and which has been converted into a serial form by the parallel/serial conversion circuit 54, from the 1.5-V system to the 2.5-V system. The multiple differential drivers 60 receive corresponding data, convert the data thus received into differential signals, and output the differential signals thus converted.

The band gap regulator 72 generates a reference voltage. The bias current source 74 generates a 100 μA reference current based upon the reference voltage, and supplies the reference current thus generated to each differential driver 60.

Furthermore, the amplifier 76 generates a midpoint voltage VCM (=1.25 V) for the power supply voltage MVdd (=2.5 V) based upon the reference voltage, and supplies the midpoint voltage to each differential driver 60. Each differential driver 60 outputs a differential signal which swings with the midpoint voltage VCM as the center point.

While the preferred embodiments of the present invention have been described using specific terms, such description is for illustrative purposes only, and it is to be understood that changes and variations may be made without departing from the spirit or scope of the appended claims.

What is claimed is:

1. A timing control circuit connected via a common bus to a plurality of data drivers configured to drive a display panel, the timing control circuit comprising:
a reception interface circuit configured to receive luminance data provided for each color;
a timing control unit configured to control the timing of the luminance data for each color such that they conform to the plurality of data drivers provided as transmission destinations; and
a transmission interface circuit configured to transmit luminance data, which has been provided for each color and the timing of which has been controlled by the timing control unit, and a synchronization clock, to the plurality of data drivers via the common bus,
wherein the transmission interface circuit is configured so as to independently adjust the respective phases of the synchronization clock and the luminance data provided for each color to be output to the bus.

2. A timing control circuit according to claim 1, further comprising an oscillator configured to generate a multi-phase clock including a plurality of clocks having phases that differ from one another,
wherein the transmission interface circuit is configured to select, from among the plurality of clocks included in the multi-phase clock, one clock that corresponds to the phase required for the synchronization clock, and to generate the synchronization clock based upon the clock thus selected,
and wherein the transmission interface circuit is configured to select, from among the plurality of clocks included in the multi-phase clock, one clock that corresponds to the phase required for the luminance data for each color, to retime the luminance data for each color using the clock thus selected, and to output the luminance data thus retimed.

3. A display apparatus comprising:
a display panel;
at least one scanning driver configured to drive the display panel;
a plurality of data drivers configured to drive the display panel; and
a control circuit according to claim 1, configured to transmit luminance signals to the data drivers.

4. A timing control circuit according to claim 1, wherein the luminance data input to the reception interface circuit is a differential signal.

5. A timing control circuit according to claim 1, wherein the luminance data, which are output from the reception interface circuit and constitute the data for a single pixel, are each 8-bit signals.

6. A timing control circuit according to claim 1, wherein the bus includes twelve data lines and a single clock line.

7. A timing control circuit according to claim 1, wherein each line of the bus is provided as a pair of differential lines.

8. A timing control circuit according to claim 1, wherein the transmission interface circuit comprises a clock parallel/serial conversion circuit and data parallel/serial conversion circuits respectively provided to bit lines for the synchronization clock and the luminance data.

9. A timing control circuit according to claim 8, wherein the clock parallel/serial conversion circuit comprises:
a selector configured to receive a plurality of clocks, and to select one clock set beforehand; and
a flip-flop configured to latch the data input via a first input terminal at a positive edge timing of the clock thus selected by the selector, and to latch the data input via a second input terminal at a negative edge timing thereof.

10. A timing control circuit according to claim 8, wherein the data parallel/serial conversion circuit comprises:
a selector configured to receive a plurality of clocks, and to select one clock set beforehand; and
a flip-flop configured to latch first data input via a first input terminal at a timing of a positive edge of the clock thus selected by the selector, and to latch second data input via a second input terminal at a timing of a negative edge thereof.

11. A timing control circuit comprising:
a plurality of input terminals arranged such that a clock signal provided in the form of a differential signal and a plurality of luminance data which are provided in the form of differential signals are input via the input terminals;
data differential receivers configured to receive the respective luminance data as input data;
serial/parallel conversion circuits each of which is configured to receive, as an input signal, the output of a corresponding differential amplifier;
a clock differential receiver configured to receive a clock signal as an input signal;
a DLL (Delay Locked Loop) circuit configured to generate a second clock signal based upon a signal received from a clock differential amplifier;
a logic unit configured to receive signals from the DLL circuit and the serial/parallel conversion circuits as input signals;
a PLL (Phase Locked Loop) circuit configured to generate a clock signal with a predetermined frequency;
a parallel/serial conversion circuit configured to convert data received in a parallel format from the logic unit into serial signals;
differential drivers configured to output, in the form of differential data, a plurality of data converted to the serial data format by the parallel/serial conversion circuit; and
an oscillator configured to oscillate with a frequency used as a reference frequency.

12. A timing control circuit according to claim 11, wherein the logic unit, the oscillator, and the PLL circuit each operate under a power supply voltage lower than that for the differential drivers and the differential receivers.
